(19) United States
(12) Patent Application Publication
(10) Pub. No.: US 2008/0298354 A1
(43) Pub. Date: Dec. 4, 2008

(54) Packet Signaling Content Control on a Network

(75) Inventors: David John Alves, Sudbury, MA (US); Justin Scott Hart, Swindon (GB); Gautham Nimmagadda, Boylston, MA (US)

Correspondence Address: PROSKAUER ROSE LLP, ONE INTERNATIONAL PLACE, BOSTON, MA, 02110, US

(73) Assignee: Sonus Networks, Inc., Westford, MA (US)

(21) Appl. No.: 11/755,901

(22) Filed: May 31, 2007

(51) Int. Cl. H04L 12/56

(52) U.S. Cl. 370/389

(57) ABSTRACT

Described are computer-based methods and apparatuses, including computer program products, for packet signaling content control on a network. The content control includes two sets of filters—an ingress filter set and an egress filter set. For packets coming into an internal network, the packets (e.g., SIP packets) are filtered by an ingress filter associated with the external network and which determines whether to discard sets of information from the packet description information (e.g., a header, an optional header). The packet is also filtered by an egress filter associated with the internal network and which determines whether to discard sets of information from the packet description information. The packet is transmitted to the internal network. For packets leaving the internal network, the filtering occurs in the opposite direction (e.g., egress filter associated with the internal network and then ingress filter associated with the external network).

### FIELD OF THE INVENTION

The present invention relates generally to computer-based methods and apparatuses, including computer program products, for packet signaling content control on a network.

### BACKGROUND

In general, traditional telephone networks, such as the publicly-switched telephone network (PSTN), employ circuitry and switches to connect telephone users across the network to facilitate communication. An increasing alternative to traditional phone networks uses packetized data to transmit content of telephone communications (e.g., voice or videoconferencing data) through a packet-based network such as an internet protocol (IP) and/or session initiation protocol (SIP) network. Such a configuration is commonly referred to as a voice over internet protocol (VOIP) network and can support voice, data, and video content.

The increased use of packet networks across the globe has been accompanied by an increase in attacks to those networks and an increase in the number of malformed packets being sent among the networks. An attack on a network and the increased malformed packets can cause devastating damage not only to the flow of data on the network, but to a company's reputation for allowing the flow of data to be impeded and ultimately to a company's bottom line finances.

### SUMMARY OF THE INVENTION

One approach to packet signaling content control on a network is a method. The method includes receiving a packet from a first network group. A first set of information is removed from a first set of packet description information associated with the packet based on a first set of filters associated with the first network group to form a second set of packet description information. A second set of information is removed from the second set of packet description information of the packet based on a second set of filters associated with a second network group to form a third set of packet description information. The third set of packet description information and a payload associated with the packet is transmitted to the second network group.

Another approach to packet signaling content control on a network is a computer program product. The computer program product is tangibly embodied in an information carrier. The computer program product includes instructions being operable to cause a data processing apparatus to receive a packet from a first network group. A first set of information is removed from a first set of headers associated with the packet based on a first set of filters associated with the first network group to form a second set of headers. A second set of information is removed from the second set of headers of the packet based on a second set of filters associated with a second network group to form a third set of headers. The third set of headers and a payload associated with the packet is transmitted to the second network group.

Another approach to packet signaling content control on a network is a system. The system includes a network border server, a first filter module, and a second filter module. The network border server is configured to receive a packet from a first network group. The first filter module is configured to remove a first set of information from a first set of headers associated with the packet based on a first set of filters associated with the first network group to form a second set of headers. The second filter module is configured to remove a second set of information from the second set of headers based on a second set of filters associated with a second network group to form a third set of headers. The network border server is further configured to transmit the third set of headers and a payload associated with the packet to the second network group.

Another approach to packet signaling content control on a network is a system. The system includes a means for receiving a packet from a first network group, a means for removing a first set of information from a first set of headers associated with the packet based on a first set of filters associated with the first network group to form a second set of headers, a means for removing a second set of information from the second set of headers based on a second set of filters associated with a second network group to form a third set of headers, and a means for transmitting the third set of headers and a payload associated with the packet to the second network group.

In other examples, any of the aspects above can include one or more of the following features. The packet includes a session initiation protocol (SIP) packet and the first set of information and the second set of information include optional information associated with the SIP packet. In some examples, the removing the first set of information occurs at an application layer. In other examples, the removing the second set of information occurs at an application layer.

In some examples, the packet includes a voice communication packet, an Internet Protocol (IP) packet, a SIP packet, a SIP signaling packet, session description protocol (SDP) packet, domain name system (DNS) packet, and/or hypertext transfer protocol (HTTP) packet.

In other examples, the packet includes or is associated with voice information, multimedia information, and/or text information. The first set of packet description information is identical to the second set of packet description information or the second set of packet description information is identical to the third set of packet description information, but not both. The first set of information, the second set of information, or both are not replaced in the third set of packet description information.

In some examples, the first set of filters includes an ingress filter that indicates whether information associated with the packet should be received from the first network group and the second set of filters includes an egress filter that indicates whether information associated with the packet should be transmitted to the second network group.

In other examples, the first network group includes one or more external networks and the second network group includes one or more internal networks. The first set of filters includes an ingress filter that indicates whether information associated with the packet should be received from the one or more external networks and the second set of filters includes an egress filter that indicates whether information associated with the packet should be transmitted to the one or more internal networks.

In some examples, the first network group includes one or more internal networks and the second network group includes one or more external networks. The first set of filters includes an egress filter that indicates whether information associated with the packet should be transmitted from the one or more internal networks and the second set of filters includes an ingress filter that indicates whether information associated with the packet should be sent to the one or more external networks.

In other examples, the packet description information includes one or more headers associated with the packet. The first set of filters, the second set of filters, or both includes one or more filters for one or more optional fields associated with the one or more headers. The first set of information includes a header associated with the packet, an optional field associated with the packet, metadata associated with the packet, request information associated with the packet, and/or response information associated with the packet. The second set of information includes a header associated with the packet, an optional field associated with the packet, metadata associated with the packet, request information associated with the packet, and/or response information associated with the packet.

In some examples, the first network group comprises one or more networks logically grouped together and/or the second network group comprises one or more networks logically grouped together. The one or more networks includes a packet based network, an internet protocol (IP) network, a public switched telephone network (PSTN), a wireless network, and/or a wired network.

In other examples, the network border server includes or is associated with a telephony gateway. The telephony gateway is in communication with a PSTN network and an IP network.

Any of the approaches/aspects/techniques described above can include one or more of the following advantages. An advantage to the packet signaling content control on the network is that packet signaling control can be differentiated between various packet sources (e.g., network groups). Another advantage is that the content of packets can be tailored according to the exact mix of information that needs to be passed across networks. An additional advantage is that the content of packets can be controlled based on per-network agreements. Another advantage is that each filter can be set according to the network group that is associated with the filter.

Another advantage is that unknown packet description information can be removed from the packets to protect the networks from malicious network activity. An additional advantage is that filters can be placed on untrusted networks (e.g., public networks) to remove potentially harmful network activity while still allowing the packet description information from trusted networks (e.g., private networks). Another advantage is that the ingress filter can be configured to protect against security risks from the external network group (e.g., incorrect Timestamp) while the egress filter can be configured to protect against security risks to the internal network group (e.g., charge information).

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a functional block diagram of an exemplary system illustrating packet signaling content control on a network.

FIG. 2 is a functional block diagram of an exemplary system illustrating ingress filter modules and egress filter modules on a network.

FIG. 3 is a diagram of an exemplary SIP packet.

FIG. 4 is a diagram of exemplary table illustrating the removal of headers in a packet.

FIG. 5 is a diagram of an exemplary SIP packet.

FIG. 6 is a diagram of an exemplary SIP packet.

FIG. 7 is a diagram of exemplary table illustrating the removal of headers in a packet.

FIG. 8 is a diagram of an exemplary SIP packet.

FIG. 9 is an exemplary flowchart depicting processing a packet from an external network to an internal network.

FIG. 10 is an exemplary flowchart depicting processing a packet from an internal network to an external network.

### DETAILED DESCRIPTION

In general overview, packet signaling is content controlled on a network. The content control includes two sets of filters—an ingress filter set and an egress filter set. For packets coming into an internal network, the packets (e.g., SIP packets) are filtered by an ingress filter associated with the external network and which determines whether to discard sets of information from the packet description information (e.g., a header, an optional header). The packet is also filtered by an egress filter associated with the internal network and which determines whether to discard sets of information from the packet description information. The packet is transmitted to the internal network. For packets leaving the internal network, the filtering occurs in the opposite direction (e.g., egress filter associated with the internal network and then ingress filter associated with the external network).

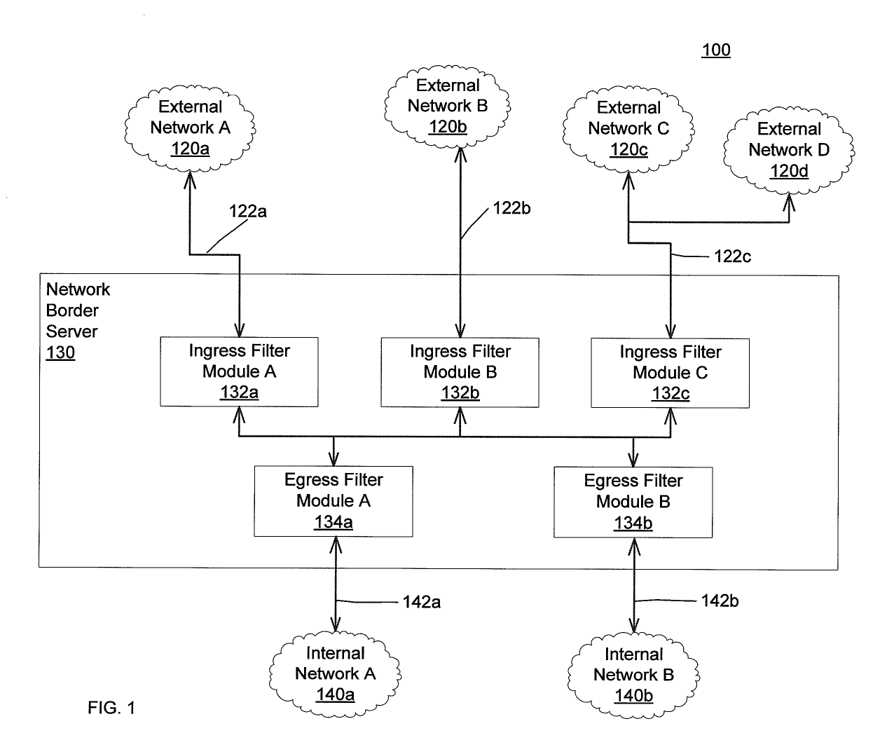

FIG. 1 is a functional block diagram of an exemplary system 100 illustrating packet signaling content control on one or more networks. The system 100 includes external networks 120a, 120b, 120c, and 120d, internal networks 140a and 140b, and a network border server 130. The network border server 130 includes an ingress filter module A 132a, an ingress filter module B 132b, an ingress filter module C 132c, an egress filter module A 134a, and an egress filter module B 134b.

Each of the ingress filter modules (e.g., 132a) and egress filter modules (e.g., 134a) is associated with a network group (e.g., 122a, 122b, 122c, 142a, 142b). A network group (e.g., 122a) can include, for example, one or more external networks (e.g., 120a), one or more internal networks (e.g., 140a), one or more logical sets of networks (e.g., a logical set of a demilitarized zone networks from ten company sites across the globe), one or more physical sets of networks (e.g., the ten subnets in one building), and/or any other grouping of networks. The logical sets of networks include, for example, one or more networks that are logically grouped together (e.g., public access networks associated with a company, limited access networks associated with a company). For example, the network group 122c includes external network C 120c and external network D 120d which is associated with the ingress filter module C 132c.

The network group can be, for example, an IP trunk group with an associated SIP service group level. The SIP service group level can be, for example, associated with a network service agreement, a use's subscription agreement, and/or any other type of service level agreements. In other examples, the network group is an IP trunk group. The IP trunk group is further described in U.S. patent application Ser. No. 11/238,663, Attorney Docket No. SNS-003A, entitled “Defining Logical Trunk Groups in a Packet-Based Network,” filed on Sep. 29, 2005, the disclosure of which is hereby incorporated herein by reference. An advantage is that the filter modules can be utilized and adapted for a wide variety of network configurations (e.g., local area networks (LAN), metropolitan area networks (MAN), wide area network (WAN), packet telephone networks).

In some examples, each ingress filter module (e.g., 132a) and each egress filter module (e.g., 134a) includes filters which filter packet description information for packets sent to and/or from an associated network group. In other examples, each egress filter module (e.g., 142a) includes one or more filters which filter packet description information, or portions thereof, from packets sent to and/or from the network group associated with the ingress filter module (e.g., 132a). Packet description information can include, for example, a header associated with the packet (e.g., To field), an optional header associated with the packet (e.g., Route field), metadata associated with the packet (e.g., packet size), request information associated with the packet (e.g., INVITE), and/or response information associated with the packet (e.g., 200 OK).

The optional header associated with the packet can be, for example, any header that is not required for the transmission of the packet from the source of the packet (e.g., cell phone) to the destination of the packet (e.g., voice mail server). An advantage is that the filters can be customized according to the specific requirements and/or needs associated with the filter module and associated network group. Another advantage is that headers that could cause more harm to a network then benefit can be removed before the packet is allowed onto the network. Another advantage is that headers that are not needed for communication between the transmitting network group and receiving network group can be removed. For example, the optional header P-Charging-Vector for a SIP packet can be removed at an egress filter if the network group associated with the egress filter does not want to receive or send the header P-Charging-Vector.

The ingress and egress filters can be configured, for example, based on network agreements. For example, internal network A 140a has a network agreement with external network A 120a to accept P-Charging-Vector information so that users can be charged for network access. The ingress filter associated with ingress filter module A 132a will allow the P-Charging-Vector information to be sent to the egress filter module A 134a. The egress filter associated with egress filter module A 134a will allow P-Charging-Vector information since the internal network A 140a has a network agreement to accept such information. However, that may not be the situation for all of the networks. For example, a packet is sent from external network A 120a to the internal network B 140b which does not have a network agreement to accept P-Charging-Vector information. The P-Charging-Vector information is send to the egress filter module B 134b from the ingress filter module A 132a. The egress filter associated with the egress filter module B 134b is configured to not allow P-Charging-Vector information. Thus, the P-Charging-Vector information is removed from the packet description information by the egress filter module B 134b and the packet is transmitted to the internal network B 140b without the P-Charging-Vector information.

In some examples, the packet includes voice information (e.g., speech, digitally recorded speech), multimedia information (e.g., movies, animations), text information (e.g., books, text message) and/or any other information associated with a telecommunication network. The packet can be, for example, associated with voice information, multimedia information, text information and/or any other information associated with a telecommunication network. The packet can be, for example, a packet to initiate a voice communication, a text communication, and/or a multimedia communication.

In some examples, the network border server 130 includes a telephony gateway. The network border server 130 can be, for example, associated with a telephony gateway. The telephony gateway can be, for example, in communication with a PSTN and an IP network.

Although FIG. 1 illustrates the network border server 130 between the external networks (e.g., 120a) and internal networks (e.g., 140a), the networks can be, for example, the same network (e.g., a LAN, a MAN, a WAN) with the network border server 130 controlling the content between one or more logical parts of the same network. For example, Company A has a LAN and five departments (e.g., human resources, production, engineering, sales, information technology (IT)). The IT department can be associated with an egress filter module (e.g., 134a) and each of the other departments can be associated with its own ingress filter module (e.g., 132a, 132b). Thus, the network border server 130 can control the content between the five departments of Company A based on the filters in the respective ingress filter modules and egress filter module. Another advantage is that the content control can be utilized to prevent and/or stop malicious packet description information from being sent between different parts of the same network (e.g., an internal attack on a network).

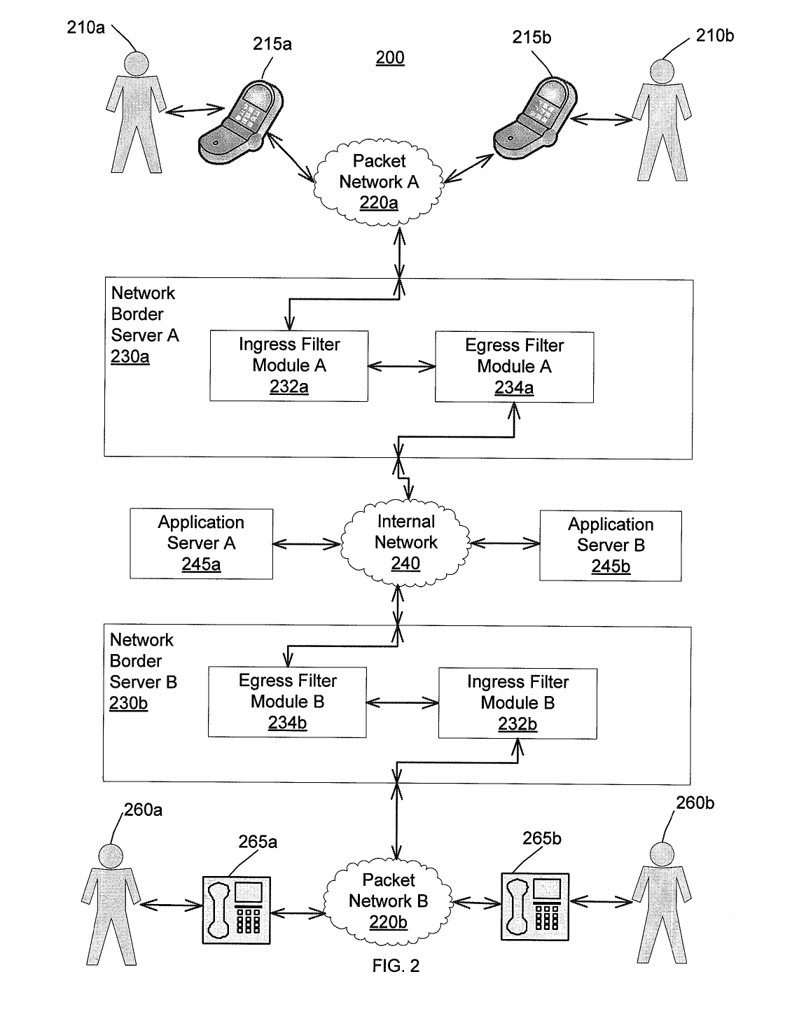

FIG. 2 is a functional block diagram of an exemplary system 200 illustrating ingress filter modules (e.g., 232a) and egress filter modules (e.g., 234a) on a network. The system 200 includes users 210a, 210b, 260a, and 260b (generally 210) who utilize computing devices 215a, 215b, 265a, and 265b (generally 215), respectively, to communicate with each other and/or with application servers A 245a and B 245b (generally 245). The system 200 includes network border servers 230a and 230b (generally 230) which include the ingress filter modules 232a and 232b (generally 232) and egress filter modules 234a and 234b (generally 234), respectively. The ingress filter modules 232a and 234b are associated with packet networks 220a and 220b (generally 220), respectively. The egress filter modules 234a and 234b are associated with the internal network 240. The application servers A 245a and B 245b communicate with each other and with the user's computing devices 215 utilizing the internal network 240.

In some examples, the application server 245 includes a voicemail server, a text message server, a reservation server, a global positioning system (GPS) server, and/or any other server which provides services to users on a telecommunications network. Another advantage is that the user 210 can utilize services (e.g., voicemail) on the telecommunications network while the internal service network is being protected from malicious activity and/or malformed packets that could disrupt the service on and/or harm the internal service network.

In other examples, the internal network 240 is a service network for communicating between one or more packet networks 220 and for providing access to application servers 245. The internal network 240 can be, for example, a private packet based network, a public packet based network (e.g., Internet), and/or a virtual private network (VPN) on a public packet based network.

For example, the user 210b utilizes his computing device 215b (e.g., cell phone) to send a SIP request packet (e.g., INVITE) to request a connection between the computing device 215b and the application server B 245b (e.g., voice mail server). The SIP request packet includes a plurality of headers (e.g., From, To, Route, Timestamp). The SIP request packet is transmitted through the packet network A 220a (e.g., Internet, VPN connection over a public network, private packet network). The network border server A 230a receives the SIP request packet. The SIP request packet is sent to the ingress filter module A 232a which is associated with the transmitting network group. The transmitting network group includes the packet network A 220a. The ingress filter module A 232a processes the headers in the SIP request packet to determine whether the headers should be processed. The ingress filter associated with the ingress filter module A 232a is configured not to process Route headers from the transmitting network group (in this example, the packet network A 220a). The Route header is removed from the SIP request packet.

The SIP request packet without the Route header is sent to the egress filter module A 234a which is associated with the receiving network group. The receiving network group includes the internal network 240. The egress filter module A 234a processes the headers in the SIP request packet to determine whether the headers should be transmitted to the receiving network group. The egress filter associated with the egress filter module A 234a is configured not to transmit Timestamp headers to the receiving network group (in this example, the internal network 240). The Timestamp header is removed from the SIP request packet. The SIP request packet without the Route header and Timestamp header is transmitted to the receiving network group (in this example, the internal network 240). The SIP request packet is transmitted to the application server B 245b for processing.

The application server B 245b responds to the SIP request packet from the user's computing device 215b with a SIP response packet (e.g., 200 OK). The SIP response packet includes a plurality of headers (e.g., From, To, Route, Timestamp). The SIP response packet is transmitted through the internal network 240 to the network border server A 230a. The SIP response packet is sent to the egress filter module A 234a which is associated with the transmitting network group. The transmitting network group includes the internal network 240. The egress filter module A 234a processes the headers in the SIP response packet to determine whether the headers should be processed. The egress filter associated with the egress filter module A 234a is configured not to process Timestamp headers from the transmitting network group (in this example, the internal network 240). The Timestamp header is removed from the SIP response packet.

The SIP response packet without the Timestamp header is sent to the ingress filter module A 232a which is associated with the receiving network group. The receiving network group includes the packet network A 220a. The ingress filter module A 232a processes the headers in the SIP response packet to determine whether the headers should be transmitted to the receiving network group. The ingress filter associated with the ingress filter module A 232a is configured not to transmit Route headers to the receiving network group (in this example, the packet network A 220a). The Route header is removed from the SIP response packet. The SIP response packet without the Timestamp header and Route header is transmitted to the receiving network group (in this example, the packet network A 220a). The SIP response packet is transmitted to the user's computing device 215b.

In other examples, the ingress filter module (e.g., 232a) is associated with a single physical network (e.g., LAN, WAN, MAN). The egress filter module (e.g., 234a) also can be associated, for example, with a single physical network (e.g., LAN, WAN, MAN).

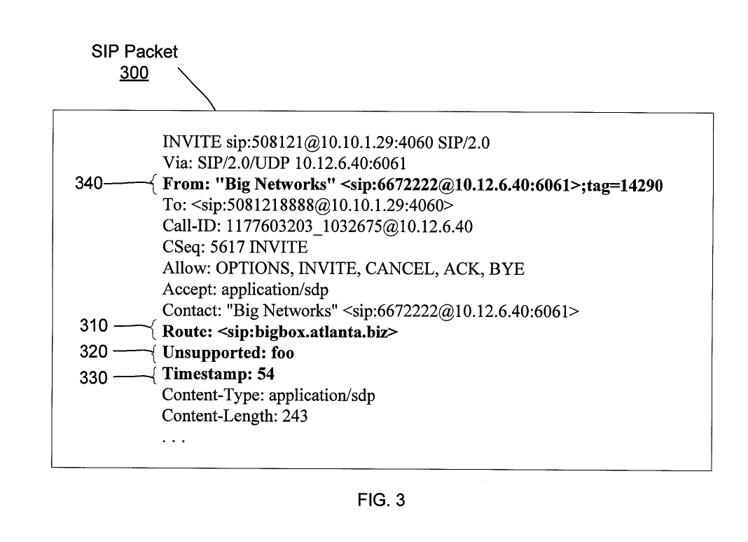

FIG. 3 is a diagram of an exemplary SIP packet 300. The SIP packet 300 includes headers 310, 320, 330, and 340. The headers provide, for example, information to route and/or process the packet at routers, network devices, and/or the destination device for the packet (e.g., computing device, cell phone, voicemail server, text message server). In some examples, the headers include mandatory information (e.g., To, From) and/or optional information (e.g., Route, Timestamp).

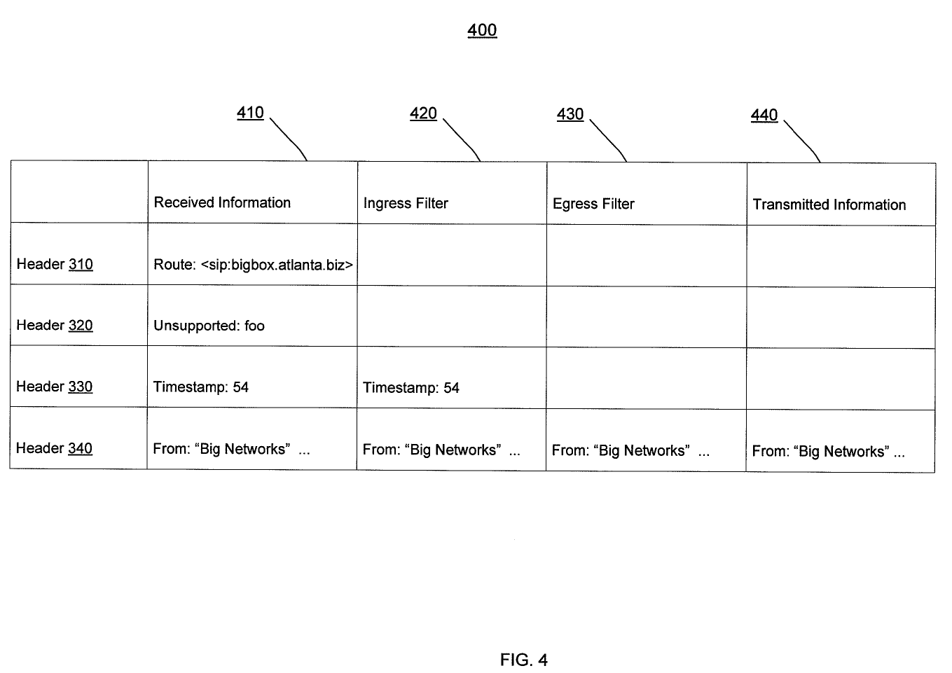

FIG. 4 is a diagram of exemplary table 400 illustrating the removal process of sets of information (e.g., one or more particular headers) from the packet description information (e.g., the group of all of the SIP headers) in the SIP packet 300 of FIG. 3. The table 400 illustrates a set of received information 410, which is a portion of all of the information associated with the SIP packet 300. The received information 410 includes the headers 310, 320, 330, and 340. The table 400 illustrates that the headers 310 and 320 are removed by the ingress filter 420 and that the header 330 is removed by the egress filter 430. The table 400 illustrates the transmitted information 440, which is the only portion of the set of received information 410 that remains as part of the packet after the packet is processed by the ingress and egress filters.

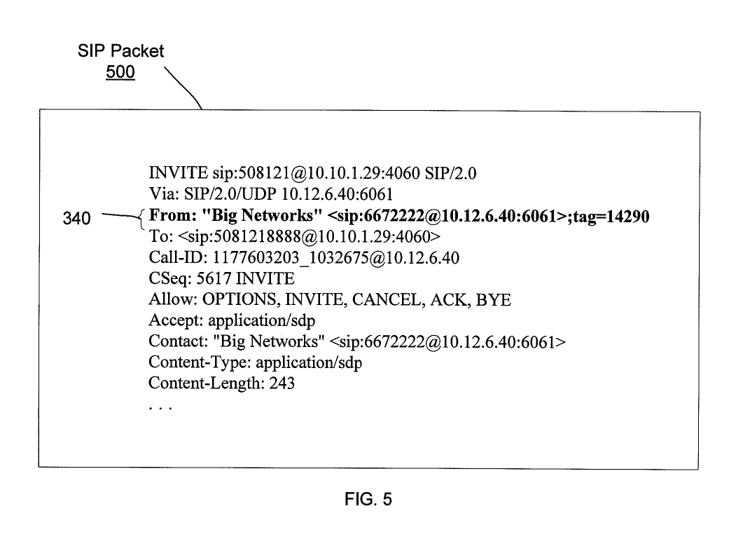

FIG. 5 is a diagram of an exemplary SIP packet 500 which is filtered from the SIP packet 300 of FIG. 3 as illustrated by table 400 of FIG. 4. The ingress filter 420 and egress filter 430 remove headers 310, 320, and 330 of the SIP packet 300 to form the SIP packet 500, which retains the header 340 associated with a From field.

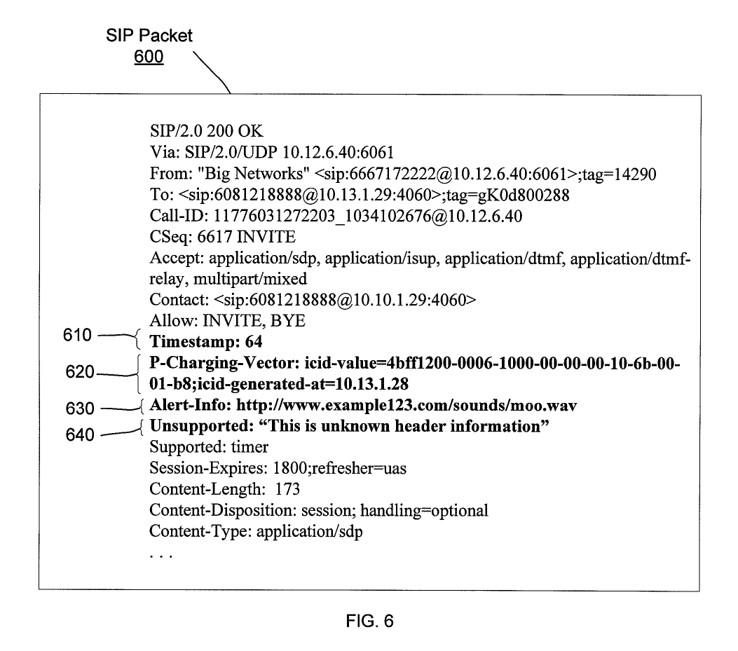

FIG. 6 is a diagram of an exemplary SIP packet 600. The SIP packet 600 includes headers 610, 620, 630, and 640. The headers provide, for example, information to route and/or process the packet at routers, network devices, and/or the destination device for the packet (e.g., computing device, cell phone, voicemail server, text message server). In some examples, the headers include mandatory information (e.g., to, from) and/or optional information (e.g., route, timestamp).

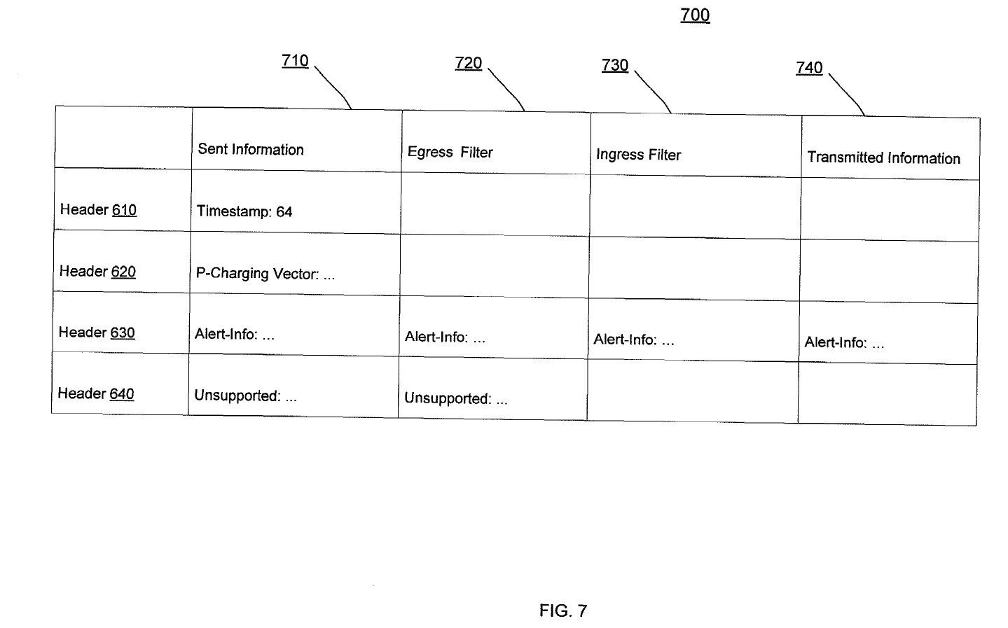

FIG. 7 is a diagram of exemplary table 700 illustrating the removal process of sets of information (e.g., one or more particular headers) from the packet description information (e.g., the group of all of the SIP headers) in the SIP packet 600 of FIG. 6. The table 700 illustrates a set of sent information 710 which is a portion of all of the information associated with the SIP packet 600. The sent information 710 includes the headers 610, 620, 630, and 640. The table 700 illustrates that the headers 610 and 620 are removed by the egress filter 720 and that the header 640 is removed by the ingress filter 730. The table 700 illustrates the transmitted information 740, which is the only portion of the set of sent information 710 that remains as part of the packet after the packet is processed by the ingress and egress filters.

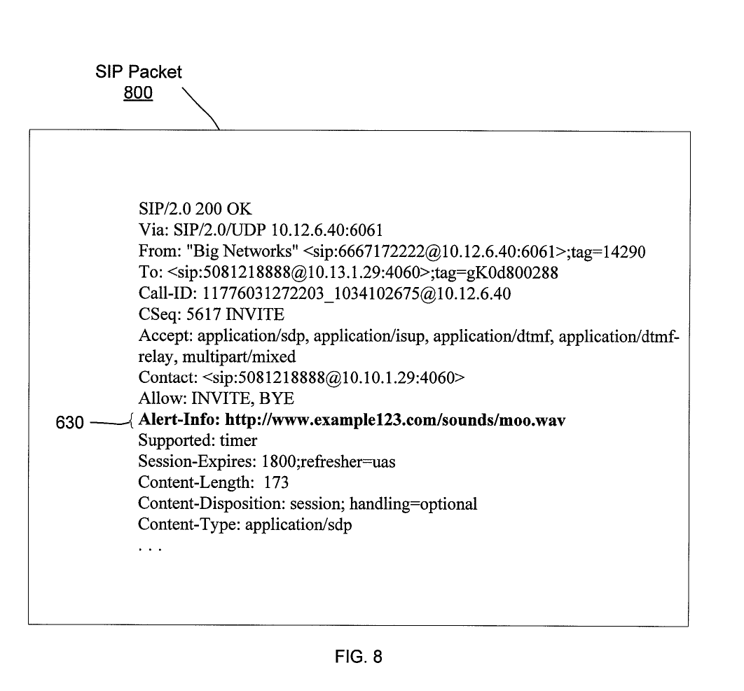

FIG. 8 is a diagram of an exemplary SIP packet 800 which is filtered from the SIP packet 600 of FIG. 6 as illustrated by table 700 of FIG. 7. The egress filter 720 and ingress filter 730 remove headers 610, 620, and 630 of the SIP packet 600 to form the SIP packet 800 which retains the header 630 associated with a Alert-Info field.

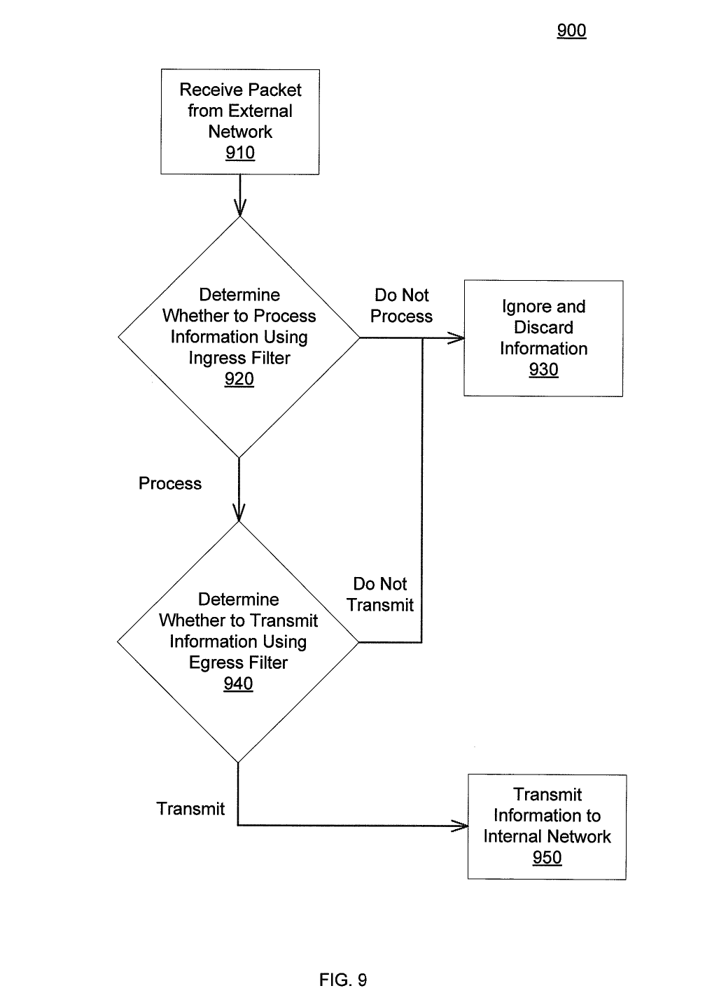

FIG. 9 is an exemplary flowchart 900 depicting processing a packet from an external packet network A 220a to an internal network 240 through the exemplary system 200 of FIG. 2. The user 210a utilizes a computing device 215a (e.g., cell phone) to transmit a packet over the external packet network 220a. The network border server A 230a receives (910) the packet from the external packet network 220a. The ingress filter module A 232a determines (920) whether to process packet description information (e.g., headers) associated with the packet using an ingress filter. The ingress filter includes filters configured to determine (920) whether sets of information (e.g., one or more headers) from the packet description information (e.g., the group of all packet headers) received from the associated external packet network 220a should be processed or ignored and discarded (e.g., removed from the packet description information). The sets of information from the packet description information that should not be processed, if any, are ignored and discarded (930).

The sets of information from the packet description information that should be processed are sent to the egress filter module A 234a. The egress filter module A 234a determines (940) which sets of information from the packet description information to transmit using a egress filter. The egress filter includes filters configured to determine (940) whether sets of information from the packet description information should be transmitted to the internal network 240. The sets of information from the packet description information that should not be transmitted are ignored and discarded (930) (e.g., removed from the packet description information). The sets of information from the packet description information that should be transmitted to the internal network 240 are transmitted (950) to the internal network 240. An advantage is that the ingress filter can be configured to never allow specified sets of information from the packet description information onto and/or from the internal network. Another advantage is that the egress filter can be configured to never accept specified sets of information from the packet description information from and/or to an external network.

For example, the SIP packet 300 of FIG. 3 is received (910) from an external packet network 220a of FIG. 2. The ingress filter module A 232a determines (920) which set of headers (e.g., 310, 320, 330, and 340) associated with the packet to process and which set of headers associated with the packet to remove based on an ingress filter. The ingress filter module A 232a utilizing the ingress filter ignores and discards (930) (in this example, removes the set of headers from the packet) the header 310 associated with a Route field and the header 320 associated with Unsupported fields (e.g., 420 in Table 400). The packet with the remaining headers (e.g., 330, 340, and other headers illustrated in the SIP packet 500 of FIG. 5) is sent to the egress filter module A 234a. The egress filter module A 234a determines (940) which set of headers (e.g., 330 and 340) to transmit to the internal network 240 and which set of headers associated with the packet to remove based on an egress filter. The egress filter module A 234a utilizing the egress filter ignores and discards (930) the header 330 associated with the Timestamp field. The packet with a remaining a set of headers as illustrated by the SIP packet 500 of FIG. 5 is transmitted (950) to the internal network.

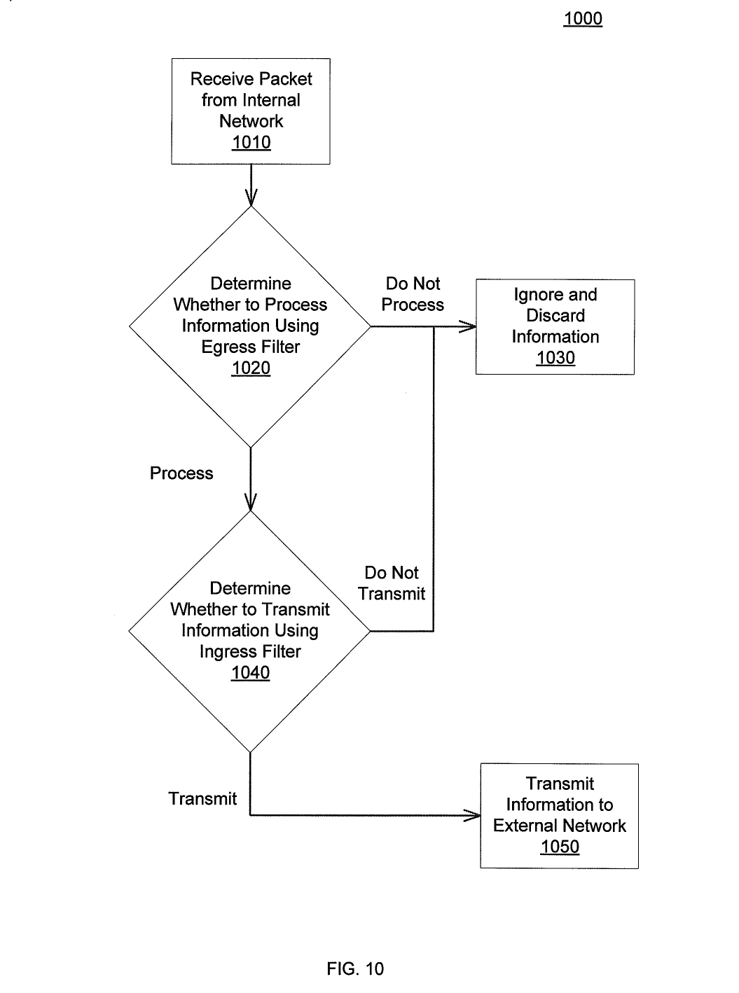

FIG. 10 is an exemplary flowchart 1000 depicting processing a packet from an internal packet network 240 to an external packet network 220a through the exemplary system 200 of FIG. 2. The application server A 245a transmits a packet over the internal packet network 240. The network border server A 230a receives (1010) the packet from the internal packet network 240. The egress filter module A 234a determines (1020) whether to process sets of information from the packet description information associated with the packet using an egress filter. The egress filter includes filters configured to determine (1020) whether sets of information from the packet description information received from the associated internal packet network 240 should be processed or ignored and discarded (e.g., removed from the packet description information). The sets of information from the packet description information that should not be processed, if any, are ignored and discarded (1030).

The sets of information from the packet description information that should be processed are sent to the ingress filter module A 232a. The ingress filter module A 232a determines (1040) which sets of information from the packet description information to transmit using an ingress filter. The ingress filter includes filters configured to determine (1040) whether sets of information from the packet description information should be transmitted to the external packet network A 220a or ignored and discarded (e.g., removed from the packet description information). The sets of information from the packet description information that should not be transmitted are ignored and discarded (1030). The sets of information from the packet description information that should be transmitted to the external packet network A 220a are transmitted (1050) to the external packet network 220a.

For example, the SIP packet 600 of FIG. 6 is received (1010) from an internal packet network 240 of FIG. 2. The egress filter module A 234a determines (1020) which set of headers (e.g., 610, 620, 630, and 640) associated with the packet to process and which set of headers to ignore and discard based on an egress filter. The egress filter module A 234a utilizing the egress filter ignores and discards (1030) a set of headers. The set of discarded headers includes the header 610 associated with a Timestamp field and the header 620 associated with a P-Charging-Vector field (e.g., 720 in Table 700). The packet with remaining set of headers (e.g., 630 and 640) is sent to the ingress filter module A 232a. The ingress filter module A 232a determines (1040) which set of headers (e.g., 630 and 640) to transmit to the external packet network A 220a and which set of headers to ignore and discard (e.g., remove from the packet description information) based on an ingress filter. The ingress filter module A 232a utilizing the ingress filter ignores and discards (1030) the set of headers that includes header 640 associated with a Unsupported field. The packet with a set of remaining headers as illustrated by the SIP packet 800 of FIG. 8 is transmitted (1050) to the external packet network A 220a.

In some examples, a packet includes packet description information and a payload (e.g., data). The ingress and egress filters remove, for example, one or more sets of information from the packet description information (e.g., Timestamp field). The sets of information from the packet description information that are not removed and the payload are transmitted, for example, to the receiving network group (e.g., internal network, external network, network group, logical network group).

In other examples, the sets of information from the packet description information (e.g., headers) that are removed by the ingress and egress filters are not replaced. For example, the packet is transmitted to the receiving network group with the sets of information from the packet description information that was not removed by the ingress and egress filters and with the payload of the packet.

In some examples, the sets of information from the packet description information that are removed by the ingress filter and/or the egress filter are replaced. The sets of information from the packet description information can be, for example, replaced with filler information (e.g., random 0s and 1s) to provide spacing for the packet. For example, if the packet is associated checksum, then the removed sets of information can be replaced with equivalent filler information from the removed sets of information so that the checksum will not be invalidated by the removal of the sets of information from the packet description information. The sets of information from the packet description information can be, for example, replaced with a standardized part associated with the sets of information removed. For example, if P-Charging-Vector: icid-value=2000; icid-generated-at=10.13.1.28 information is removed, then the information can be replaced with a standard P-Charging-Vector: icid-value=1000; icid-generated-at=10.0.0.0 part. For example, if P-Call-Payment-Type: CreditCard information is removed, then the information can be replaced with a standard P-Call-Payment-Type: NoCharge part. The sets of information from the packet description information can be, for example, replaced by dynamically generated information, information associated with the receiving network group, information associated with the transmitting network group, and/or any other packet description information.

In other examples, a packet includes sets of one or more headers (e.g., Alert-Info) and a payload. The ingress and egress filters remove, for example, sets of one or more headers. The set of headers that are not removed and the payload are transmitted, for example, to the receiving network group (e.g., internal network, external network, network group, logical network group).

In some examples, the packet includes a voice communication packet, an IP packet, a SIP packet, a SIP signaling packet, session description protocol (SDP) packet, domain name system (DNS) packet, hypertext transfer protocol (HTTP) packet, and/or any other telecommunication packet (e.g., media gateway control protocol (MGCP) packet). The SIP packet includes, for example, SIP requests (e.g., INVITE, ACK, NOTIFY) and/or SIP responses (e.g., 200 OK, 500 Server Internal Error). The SIP packet can be associated, for example, with SIP telephony.

In other examples, the sets of information from the packet description information (e.g., headers) that are removed by the ingress and egress filters are removed at any layer of a network protocol (e.g., application layer, transport layer, internet layer, data link layer, physical layer).

In some examples, the sets of information from of the packet description information (e.g., headers) that are removed by the ingress and egress filters are removed at the application layer. The application layer can be, for example, the application layer in a network protocol. The network protocol can be, for example, the Open Systems Interconnection (OSI) network protocol which consists of seven layers. For example, the application layer is the seventh layer in the OSI network protocol and interfaces with the application services in a computing device (e.g., cell phone, network border server).

The network protocol can be, for example, the transmission control protocol/internet protocol (TCP/IP) network protocol which consists of four layers. For example, the application layer is the fourth layer in the TCP/IP network protcol in which higher level protocols operate. The higher level protocols that operate at the application layer include, for example, SIP, dynamic host control protocol (DHCP), DNS, file transfer protocol (FTP), Gopher, HTTP, Internet message access protocol (IMAP), Internet relay chat (IRC), network news transfer protocol (NNTP), simple mail transfer protocol (SMTP), simple network management protocol (SNMP), real-time transport protocol (RTP), and/or any other type of application layer protocol.

Table 1 is an illustration of a set of headers received from external networks and transmitted to an internal network. Table 1 includes an illustration of the filter settings applied to the external networks and the filter settings applied to the internal network.

TABLE 1
Content Control Filters

| | | | Filter | | |
|---|---|---|---|---|---|
| | | Filters Applied to | Applied to | | |
| External | Headers | External | Internal | Headers | |
| Network | Received | Networks | Network | Transmitted | |
| A | H1, H2, H3 | H1 = Allow | H1 = Allow | H1 | Internal |
| | | H2 = Remove | H2 = Allow | | Network |
| | | H3 = Remove | H3 = Remove | | |
| B | H1, H2, H3 | H1 = Remove | | H2 | |
| | | H2 = Allow | | | |
| | | H3 = Remove | | | |
| C | H1, H2, H3 | H1 = Allow | | H1, H2 | |
| | | H2 = Allow | | | |
| | | H3 = Allow | | | |
| D | H1, H2, H3 | HA = Remove | | None | |
| | | HB = Remove | | | |
| | | HC = Remove | | | |

Table 2 is an illustration of a set of headers received from an internal network and transmitted to external networks. Table 2 includes an illustration of the filter settings applied to the external networks and the filter settings applied to the internal network.

TABLE 2
Content Control Filters

| | | Filters | | | |
|---|---|---|---|---|---|
| | | Applied to | Filter Applied to | | |
| | Headers | Internal | External | Headers | External |
| | Received | Networks | Network | Transmitted | Network |
| Internal | H1, H2, H3 | H1 = Allow | H1 = Allow | H1 | A |
| Network | | H2 = Allow | H2 = Remove | | |
| | | H3 = Remove | H3 = Remove | | |
| | | | H1 = Remove | H2 | B |
| | | | H2 = Allow | | |
| | | | H3 = Remove | | |
| | | | H1 = Allow | H1, H2 | C |
| | | | H2 = Allow | | |
| | | | H3 = Allow | | |
| | | | HA = Remove | None | D |
| | | | HB = Remove | | |
| | | | HC = Remove | | |

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

The components of the system can be interconnected by any form or medium of digital data communication (e.g., a communication network). Examples of communication networks include a LAN, WAN, the Internet, wired networks, and/or wireless networks.

The networks can be, for example, a wireless network and/or a wired network. The networks can be, for example, a packet-based network and/or a circuit-based network. Packet-based networks can include, for example, the Internet, a carrier internet protocol (IP) network (e.g., LAN, WAN, campus area network (CAN), MAN, home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile computing device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for packet signaling content control on a network, the method comprising:
receiving a packet from a first network group;
removing a first set of information from a first set of packet description information associated with the packet based on a first set of filters associated with the first network group to form a second set of packet description information;
removing a second set of information from the second set of packet description information of the packet based on a second set of filters associated with a second network group to form a third set of packet description information; and
transmitting the third set of packet description information and a payload associated with the packet to the second network group.

2. The method of claim 1, wherein the packet comprises a session initiation protocol (SIP) packet and the first set of information and the second set of information comprise optional information associated with the SIP packet.

3. The method of claim 1, wherein the removing the first set of information occurs at an application layer.

4. The method of claim 1, wherein the removing the second set of information occurs at an application layer.

5. The method of claim 1, wherein the packet comprises a voice communication packet, an Internet Protocol (IP) packet, a SIP packet, a SIP signaling packet, session description protocol (SDP) packet, domain name system (DNS) packet, hypertext transfer protocol (HTTP) packet, or any combination thereof.

6. The method of claim 1, wherein the packet comprises or is associated with voice information, multimedia information, text information, or any combination thereof.

7. The method of claim 1, wherein the first set of packet description information is identical to the second set of packet description information or the second set of packet description information is identical to the third set of packet description information, but not both.

8. The method of claim 1, wherein the first set of information, the second set of information, or both are not replaced in the third set of packet description information.

9. The method of claim 1, wherein the first set of filters comprises an ingress filter that indicates whether information associated with the packet should be received from the first network group and the second set of filters comprises an egress filter that indicates whether information associated with the packet should be transmitted to the second network group.

10. The method of claim 1, wherein the first network group comprises one or more external networks and the second network group comprises one or more internal networks.

11. The method of claim 10, wherein the first set of filters comprises an ingress filter that indicates whether information associated with the packet should be received from the one or more external networks and the second set of filters comprises an egress filter that indicates whether information associated with the packet should be transmitted to the one or more internal networks.

12. The method of claim 1, wherein the first network group comprises one or more internal networks and the second network group comprises one or more external networks.

13. The method of claim 12, wherein the first set of filters comprises an egress filter that indicates whether information associated with the packet should be transmitted from the one or more internal networks and the second set of filters comprises an ingress filter that indicates whether information associated with the packet should be sent to the one or more external networks.

14. The method of claim 1, wherein the packet description information comprises one or more headers associated with the packet.

15. The method of claim 14, wherein the first set of filters, the second set of filters, or both comprises one or more filters for one or more optional fields associated with the one or more headers.

16. The method of claim 1, wherein the first set of information comprises a header associated with the packet, an optional field associated with the packet, metadata associated with the packet, request information associated with the packet, response information associated with the packet, or any combination thereof.

17. The method of claim 1, wherein the second set of information comprises a header associated with the packet, an optional field associated with the packet, metadata associated with the packet, request information associated with the packet, response information associated with the packet, or any combination thereof.

18. The method of claim 1, wherein the first network group comprises one or more networks logically grouped together and/or the second network group comprises one or more networks logically grouped together.

19. The method of claim 18, wherein the one or more networks comprise a packet based network, an internet protocol (IP) network, a public switched telephone network (PSTN), a wireless network, a wired network, or any combination thereof.

20. A computer program product, tangibly embodied in an information carrier, the computer program product including instructions being operable to cause a data processing apparatus to:
receive a packet from a first network group;
remove a first set of information from a first set of headers associated with the packet based on a first set of filters associated with the first network group to form a second set of headers;
remove a second set of information from the second set of headers of the packet based on a second set of filters associated with a second network group to form a third set of headers; and
transmit the third set of headers and a payload associated with the packet to the second network group.

21. A system for packet signaling content control on a network, the system comprising:
a network border server configured to receive a packet from a first network group;
an first filter module configured to remove a first set of information from a first set of headers associated with the packet based on a first set of filters associated with the first network group to form a second set of headers;
an second filter module configured to remove a second set of information from the second set of headers based on a second set of filters associated with a second network group to form a third set of headers; and
the network border server further configured to transmit the third set of headers and a payload associated with the packet to the second network group.

22. The system of claim 21, wherein the network border server comprises or is associated with a telephony gateway.

23. The system of claim 22, wherein the telephony gateway is in communication with a PSTN network and an IP network.

24. A system for packet signaling content control on a network, the system comprising:
a means for receiving a packet from a first network group;
a means for removing a first set of information from a first set of headers associated with the packet based on a first set of filters associated with the first network group to form a second set of headers;
a means for removing a second set of information from the second set of headers based on a second set of filters associated with a second network group to form a third set of headers; and
a means for transmitting the third set of headers and a payload associated with the packet to the second network group.
